(19) United States
(12) Patent Application Publication
(10) Pub. No.: US 2013/0159079 A1
(43) Pub. Date: Jun. 20, 2013

(54) INTERNET ACCESS THROUGH A SOCIAL NETWORK ENABLED ROUTER

(71) Applicants: JASBIR SINGH, Lafayette, CA (US); Siddharth Singh, Lafayette, CA (US)

(72) Inventors: JASBIR SINGH, Lafayette, CA (US); Siddharth Singh, Lafayette, CA (US)

(21) Appl. No.: 13/721,004

(22) Filed: Dec. 19, 2012

Related U.S. Application Data
(60) Provisional application No. 61/577,417, filed on Dec. 19, 2011.

(51) Int. Cl. G06Q 30/02

(52) U.S. Cl. CPC G06Q 30/0217
USPC 705/14.19

(57) ABSTRACT

A method includes routing, through a social network enabled router at a location of a business entity, an Internet connection request from a data processing device of a customer of the business entity at the location thereof to a web interface requiring the customer to log in with a social network identifier thereof. The method also includes redirecting, on the data processing device, the customer to another web interface requiring intervention on part of the customer by way of endorsement of the business entity on a social network through the another web interface following the customer logging into the web interface. Further, the method includes permitting, through the social network enabled router, the customer free Internet access at the location of the business entity through the data processing device solely after the customer endorsement of the business entity on the social network through the another web interface.

### CLAIM OF PRIORITY

This application is a non-provisional conversion application and claims priority from the Application Ser. No. 61/577,417 titled LEVERGING ASOCIAL GRAPH TO PROVIDE TARGATED WIRELESS ACCESS filed on Dec. 19, 2011.

### FIELD OF TECHNOLOGY

This disclosure relates generally to social media marketing and, more particularly, to methods, an apparatus and/or a system of providing Internet access through a social network enabled router.

### BACKGROUND

A business entity (e.g., a retail establishment such as a coffee shop, a car wash, a hair salon etc.) may depend on customers who spend a significant portion of time thereof in the physical location of the business entity. The business entity may want to attract new customers through discount coupons and/or discount prices on goods and/or services thereof. While the discounted prices may prove to be attractive to new customers, the same customers may not potentially return once the business entity stops providing the aforementioned discount coupons and/or the discount prices.

Moreover, as the customers spend significant time in the physical location of the business entity, the business entity may attempt to attract more customers by introducing features such as free Internet access at the location thereof. While this free Internet access may prove successful in attracting some new customers, the business entity may still be required to market the goods and/or the services thereof through traditional channels such as pamphlets, newspapers, additional coupons etc. Thus, the cost associated with providing the free Internet access is tagged onto the cost(s) of marketing, which may lead to prohibitive expenses being incurred by the business entity.

### SUMMARY

Disclosed are methods, an apparatus and/or a system of providing Internet access through a social network enabled router.

In one aspect, a method includes routing, through a social network enabled router at a location of a business entity, an Internet connection request from a data processing device of a customer of the business entity at the location thereof to a web interface requiring the customer to log in with a social network identifier thereof. The method also includes redirecting, on the data processing device, the customer to another web interface requiring intervention on part of the customer by way of endorsement of the business entity on a social network through the another web interface following the customer logging into the web interface. The another web interface is configured to operate on a platform of the social network. The social network corresponds to the social network identifier of the customer.

Further, the method includes permitting, through the social network enabled router, the customer free Internet access at the location of the business entity through the data processing device solely after the customer endorsement of the business entity on the social network through the another web interface.

In another aspect, a router configured to enable Internet access in a location of a business entity includes a memory, and a processor communicatively coupled to the memory. The processor is configured to execute instructions associated with routing an Internet connection request from a data processing device of a customer of the business entity at the location thereof to a web interface requiring the customer to log in with a social network identifier thereof, and permitting the customer free Internet access at the location of the business entity through the data processing device solely after the customer endorses the business entity on a social network through another web interface to which the customer is redirected to on the data processing device following the login thereof with the social network identifier thereof. The another web interface is configured to operate on a platform of the social network. The social network corresponds to the social network identifier of the customer.

In yet another aspect, a system includes a data processing device of a customer of a business entity at the location of the business entity, and a social network enabled router at the location of the business entity. The social network enabled router is configured to route an Internet connection request from the data processing device to a web interface requiring the customer to log in with a social network identifier thereof, and to permit the customer free Internet access at the location of the business entity through the data processing device solely after the customer endorses the business entity on a social network through another web interface to which the customer is redirected to on the data processing device following the login thereof with the social network identifier thereof. The another web interface is configured to operate on a platform of the social network. The social network corresponds to the social network identifier of the customer.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of an Internet access provision system (IAPS), according to one or more embodiments.

FIG. 2 is a virtual view of a web page through a data processing device of a customer of a business entity requiring the customer to log in with a social network identifier thereof in the process of obtaining free Internet access through the IAPS of FIG. 1.

FIG. 3 is a virtual view of a web interface through the data processing device of the customer of the business entity requiring the customer to intervene to endorse the business entity on a social network in the process of obtaining free Internet access through the IAPS of FIG. 1.

FIG. 4 is a virtual view of an alternate example of the web page of FIG. 2.

FIG. 5 is a schematic view of a router configured as a social network enabled router in the IAPS of FIG. 1, according to one or more embodiments.

FIG. 6 is an example specification of the social network enabled router in the IAPS of FIG. 1.

FIG. 7 is an illustrative view of a social networking profile of the customer following the social network endorsement of business entity in the IAPS of FIG. 1.

FIG. 8 is a virtual view of another web interface requiring the customer to enter details of the item purchased at the location of the business entity in the IAPS of FIG. 1.

FIG. 9 is a virtual view of an example social network page of a social network friend of the customer on a data processing device.

FIG. 10 is a schematic view of an analytics server associated with a third party server of a third party provider of the social network enabled router in the IAPS of FIG. 1, according to one or more embodiments.

FIG. 11 is a process flow diagram detailing the operations involved in a method of providing free Internet access to the customer of the business entity through the social network enabled router in the IAPS of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a system and/or an apparatus of Internet access through a social network enabled router. Although the present embodiments have been described with reference to specific example embodiments, it will be evident that various modifications and changes may be made to these embodiments without departing from the broader spirit and scope of the various embodiments.

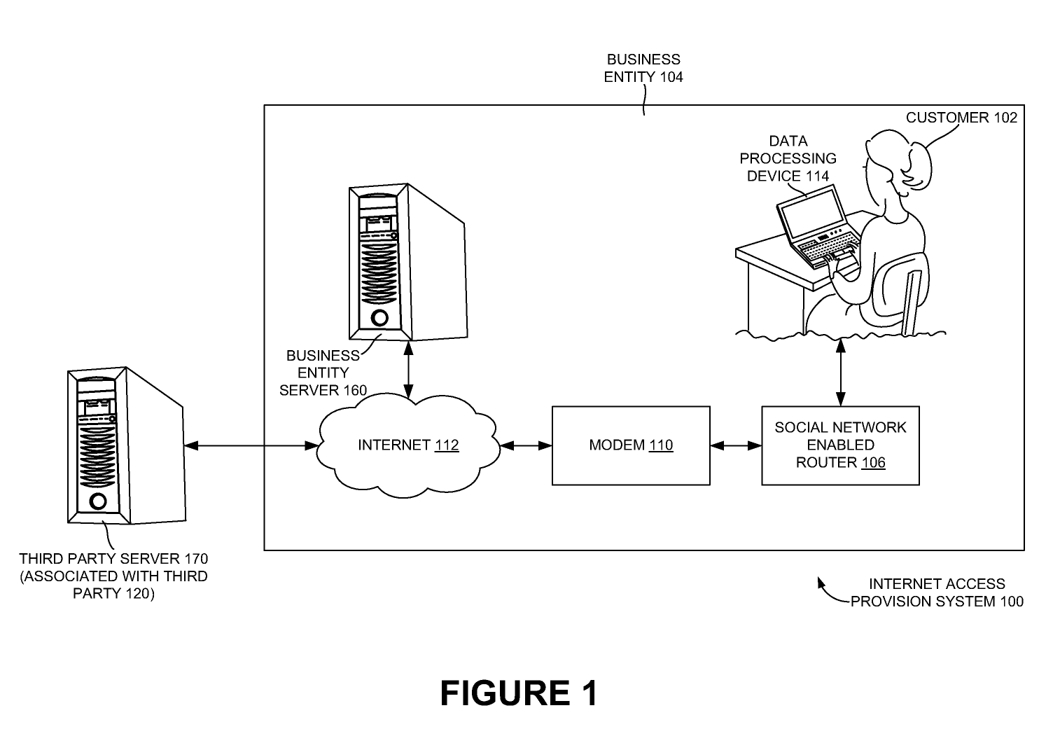

FIG. 1 shows an Internet access provision system (LAPS) 100, according to one or more embodiments. In one or more embodiments, IAPS 100 may serve the purpose of providing free Internet access to a customer 102 of a business entity 104 (e.g., a coffee shop, a hair salon, a car wash, a restaurant). In an example embodiment, business entity 104 may require marketing of services and/or goods thereof to customer(s) (e.g., including customer 102) in and around the location thereof. In one or more embodiments, a social network enabled router 106 may be located within the premises of business entity 104 and may serve the purpose of transmitting data between a modem 110 coupled to Internet 112 and a data processing device 114 (e.g., a laptop, a personal computer, a mobile phone). In one preferred embodiment, social network enabled router 106 may be coupled to modem 110, which is wirelessly configured to communicate with data processing device 114.

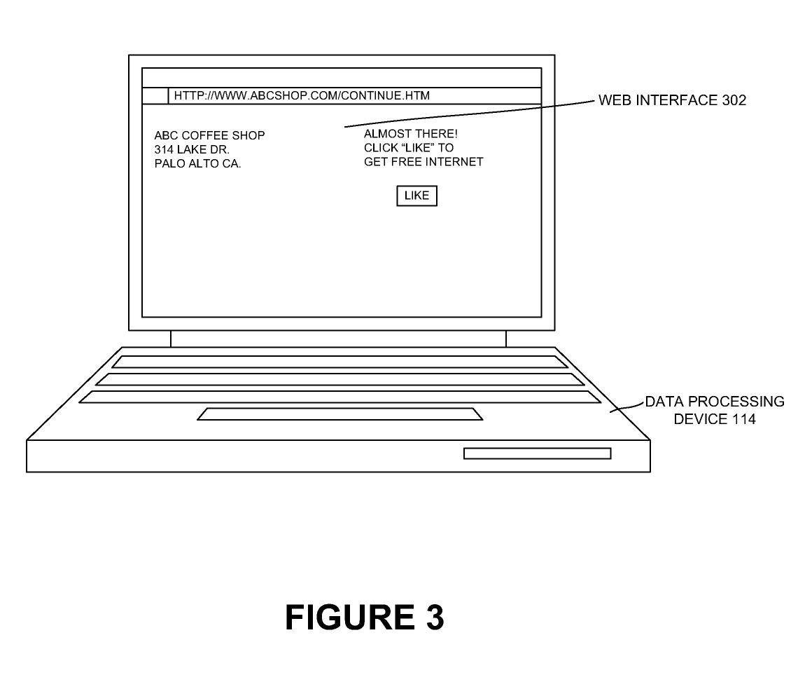

In one or more embodiments, data processing device 114 may be associated with customer 102 (e.g., belong to customer 102) of business entity 104. In one or more embodiments, business entity 104 may incentivize customer 102's patronization of the business thereof through providing free access to Internet 112 in exchange for an endorsement of business entity 104 on a social network profile (e.g., by customer 102 clicking a “Like” button associated with a facebook® profile page of business entity 104). The aforementioned example action of clicking the “Like” button is shown in FIG. 3.

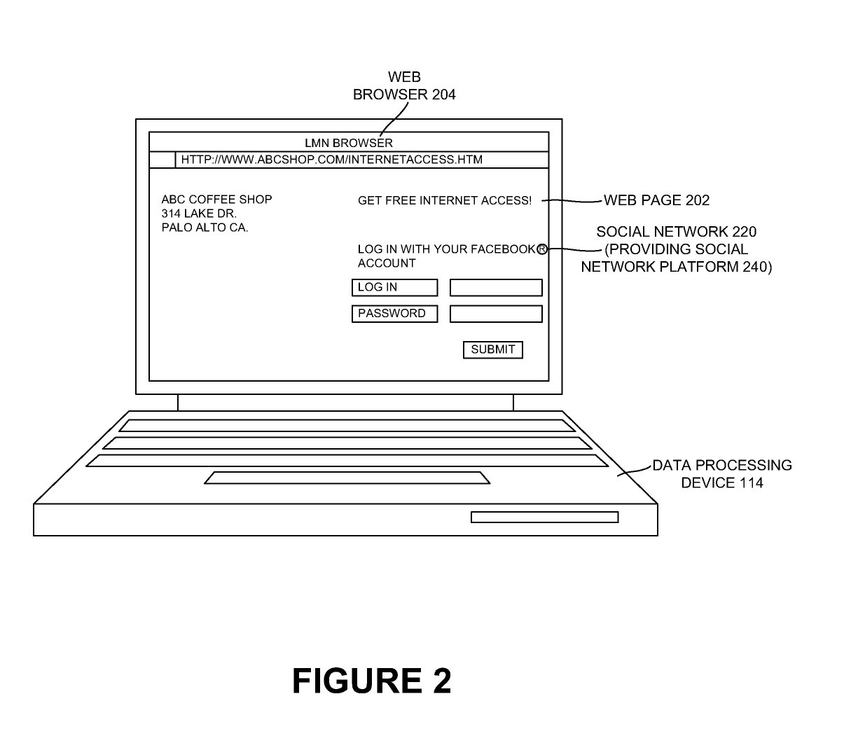

FIG. 2 illustrates the example scenario of customer 102 obtaining free access to Internet 112. Assuming business entity 104 to be a coffee shop, customer 102 may for example, purchase a coffee item such as “Almond Mocha.” Business entity 104 may advertise the free internet access (e.g., as WiFi enabled) on a signboard on the premises or on a main door thereof. Other avenues for advertising including but not limited to Internet 112, pamphlets, handouts and posters may also be explored by business entity 104. Upon being served the “Almond Mocha” item, customer 102 may opt to connect to Internet 112 through data processing device 114 (e.g., a laptop, a mobile phone with WiFi capability) thereof. FIG. 2 shows a laptop as an example data processing device 114. Data processing device 114 may detect a list of one or more computer networks within a range thereof, including the computer network associated with business entity 104.

Upon customer 102 attempting to connect to the computer network associated with business entity 104, social network enabled router 106 may redirect customer 102 to a web page 202 on a web browser 204 of data processing device 114 that requires customer 102 to login with a social networking profile ID and password (e.g., facebook® e-mail address and password) thereof, as shown in FIG. 2. As shown in FIG. 3, after customer 102 submits the aforementioned details, customer 102 may be redirected to a web interface 302 associated with web page 202, with web interface 302 providing an interface for customer 102 to endorse business entity 104 on a social network 220 (e.g., Facebook®) corresponding to the social networking identifier thereof through a “Like” button (an example of a requirement of customer 102 to intervene on web interface 302 to endorse business entity 104). It is obvious that web interface 302 operates on a platform of social network 220. Upon customer 102 clicking the “Like” button, web interface 302 may enable customer 102 to load a webpage of preference on web browser 204, thereby providing access to Internet 112. Prior to having access to Internet 112, any web page that customer 102 attempts to load on web browser 204 may be redirected to web page 202 through social network enabled router 106. Thus, any direct or indirect Internet connection request on part of customer 102 may be redirected to web page 202.

It is obvious that customer 102 may be denied access to Internet 112 based on entering the wrong social network details. As third party server 170 (coupled to data processing device 114 through Internet 112; also see below) associated with a third party 120 providing social network enabled router 106 to business entity 104 may utilize a platform of a social network corresponding to the social networking identifier of customer 102, the denial (and authentication of customer 102) may be effected through the aforementioned platform of the social network.

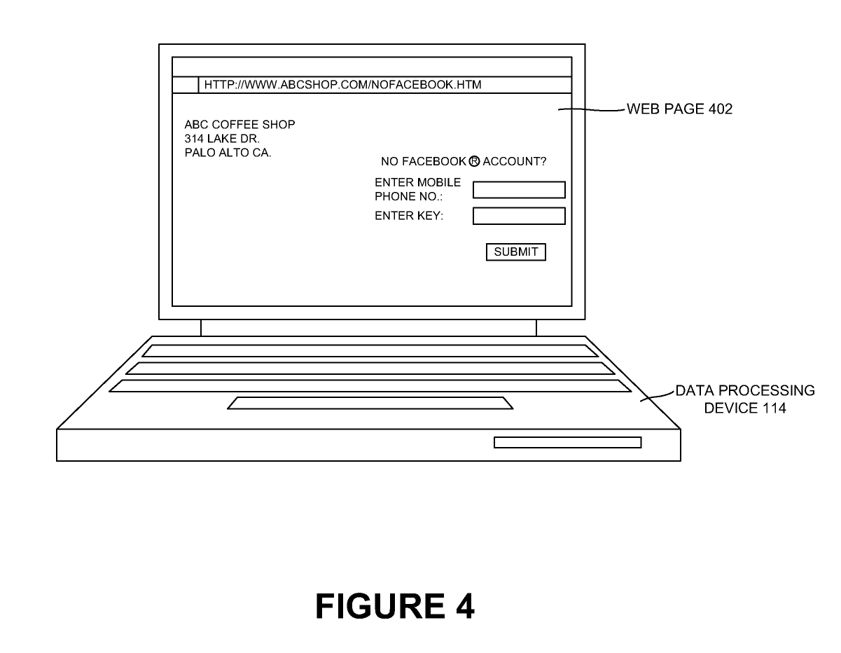

FIG. 4 shows an alternate example implementation of providing access to Internet 112 to customer 102. Here, customer 102 may be required to enter the mobile phone (example data processing device 114) number thereof, along with a social networking profile ID and password. Upon customer 102 entering the aforementioned details, a text message may be communicated to the mobile phone on behalf of business entity 104 or the provider of social network enabled router 106 (to be discussed later), with the text message including a key (e.g., a randomly generated key) to be entered at a destination web page 402 (the default web page to which traffic is redirected to by social network enabled router 106) reached when customer 102 attempts to connect to Internet 112, as shown in FIG. 4. Upon entering the aforementioned key on web page 402, web interface 302 is presented to customer 102, following which customer 102 may click the “Like” button to gain the free access to Internet 112.

Other implementations of providing free Internet 112 access in exchange for a social network endorsement from customer 102 are within the scope of the exemplary embodiments. In one or more embodiments, business entity 104 may purchase social network enabled router 106 from third party 120 (refer to FIG. 1). In one or more embodiments, third party 120 may configure social network enabled router 106 on behalf of business entity 104 appropriately such that a representative of business entity 104 (or, a representative of third party 120) may merely be required to couple social network enabled router 106 to modem 110 in order to achieve functionality thereof.

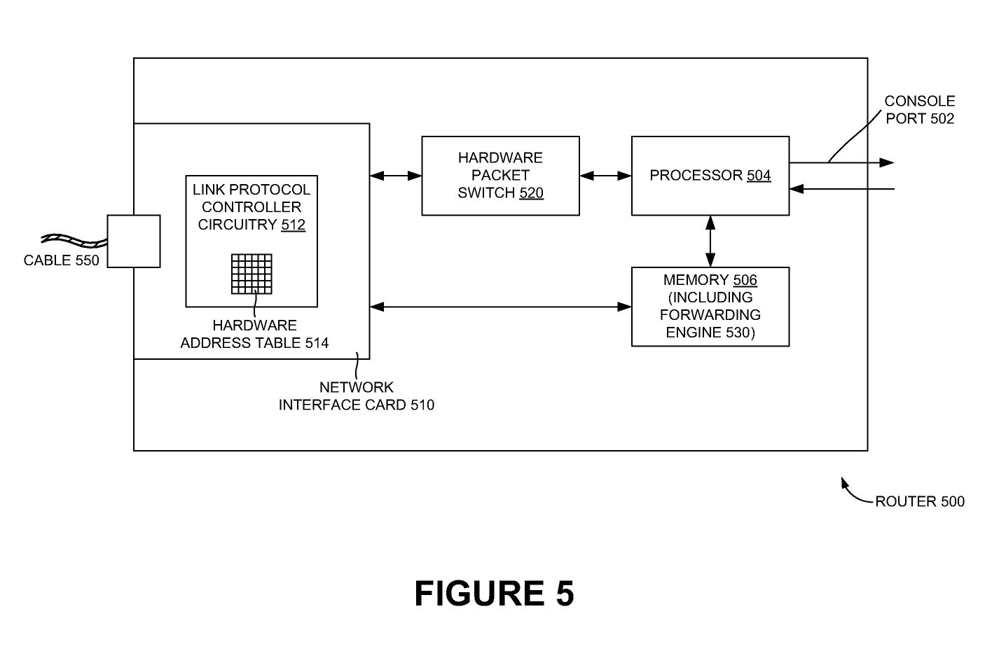

FIG. 5 shows a schematic of a router 500 to be configured as social network enabled router 106, according to one or more embodiments. In one or more embodiments, router 500 may have a console port 502 configured to enable coupling of router 500 to a modem (e.g., modem 110). In one or more embodiments, console port 502 may be utilized to configure router 500 upon first installation thereof. In one or more embodiments, router 500 may include a processor 504 configured to execute instructions associated with the functionality of router 500 such as forwarding data packets and routing data packets. In an alternate implementation, a number of processors (not shown) may together implement the functionality associated with router 500.

In one or more embodiments, a network interface card 510 configured to enable interfacing between router 500 and modem 110 may be coupled to processor 504 by way of a hardware packet switch 520. In an alternate implementation, router 500 may include a number of network interface cards (not shown). In one or more embodiments, network interface card 510 may include link protocol controller circuitry 512 (e.g., a chip) to process received data packets through handling the link protocol (e.g., Ethernet) used over the physical link coupled to cable 550, to verify frame integrity and to convert valid frames into packets to be queued. In one or more embodiments, router 500 may include a memory 506 communicatively coupled to processor 504. In one or more embodiments, memory 506 (alternatively, one can consider a number of memories) may also be communicatively coupled (or, associated with) to link protocol controller circuitry 512 and may have a forwarding engine 530 implemented in router 500 stored therein. In one or more embodiments, processor 504 may also be associated with link protocol controller circuitry 512 either as a part thereof or as an external processor thereto.

In one or more embodiments, link protocol controller circuitry 512 may also include a hardware address table 514 to locate hardware addresses of data processing device(s) (e.g., data processing device 114; and, optionally, other routers) coupled to cable 550. In one or more embodiments, link protocol controller circuitry 512 may be configured to redirect customer 102 to default web page 202 and queue the request from customer 102 for a desired web page. In one or more embodiments, upon customer 102 clicking the “Like” button in web interface 302 after entering the social networking ID and password thereof in web page 202, the web page desired by customer 102 may be loaded on web browser 204, following which the request is released from the queue.

It is obvious that the same discussion above applies to the alternative implementation discussed in FIG. 4. Also, one of ordinary skill in the art would be familiar with the functioning and components of a router and, therefore, detailed discussion thereof has been skipped for the sake of convenience and brevity.

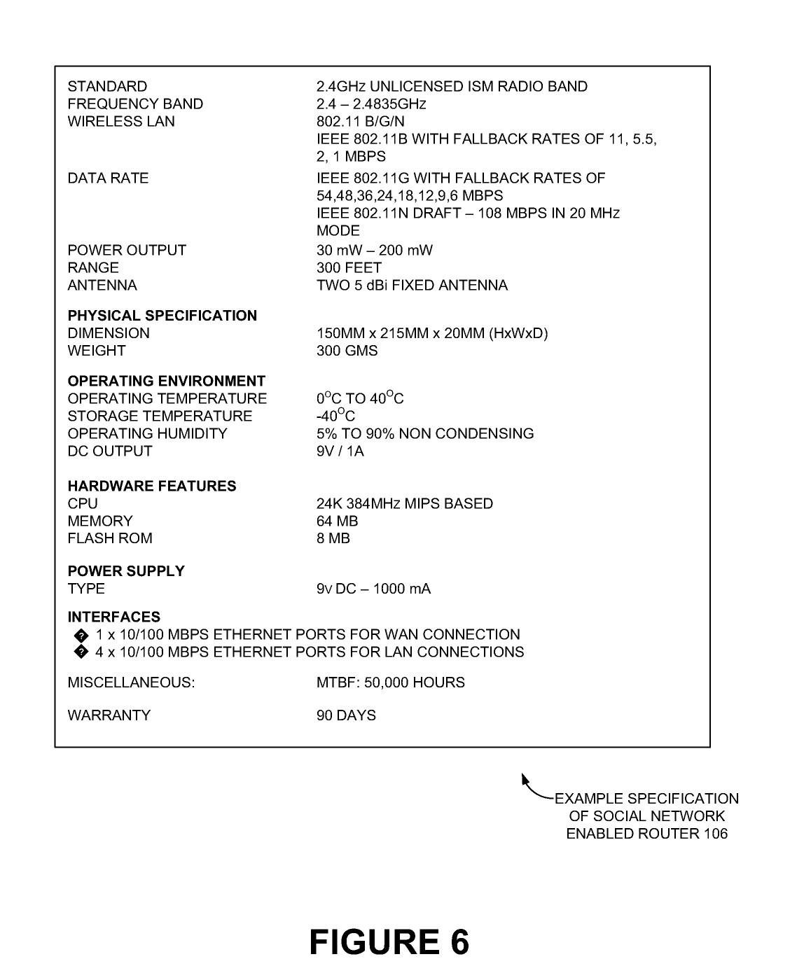

FIG. 6 shows an example specification of social network enabled router 106. One of ordinary skill in the art would, again, be familiar with the details listed in the specification and, therefore, listing of each of the aforementioned details has been skipped for the sake of brevity and convenience. Variations in the aforementioned details, of course, are within the scope of the exemplary embodiments.

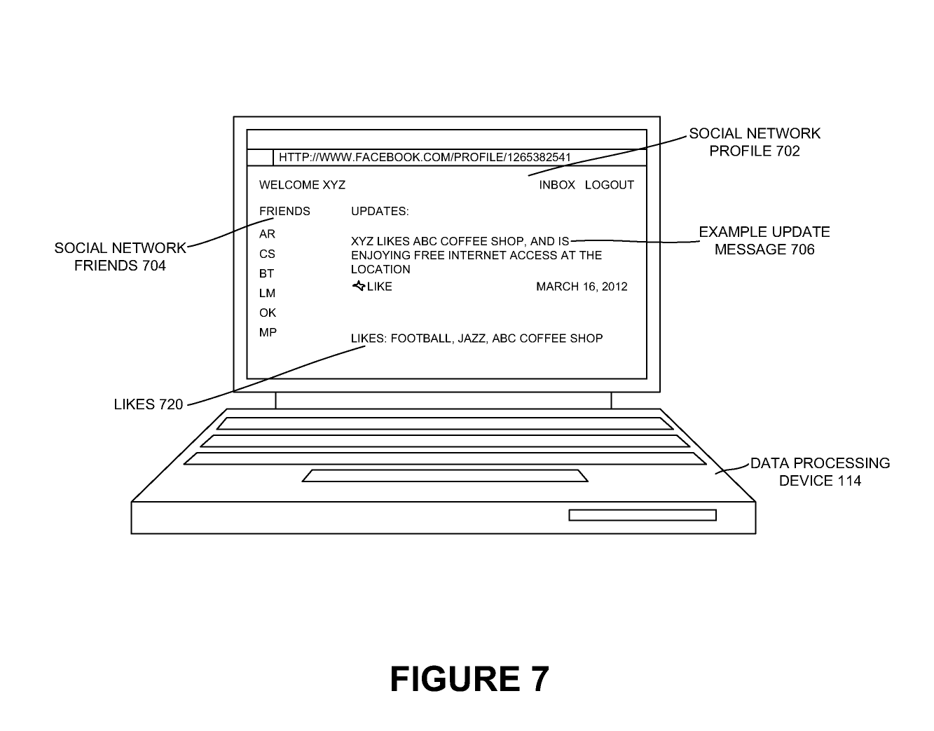

FIG. 7 shows social networking profile 702 of customer 102 following the social network endorsement of business entity 104. After the customer 102 clicks the “Like” button on web interface 302 and gains access to Internet 112, the platform (e.g., social network platform 240) of social network 220 may be triggered to post a message on social networking profile 702 of customer 102, thereby updating social network friends 704 of customer 102 with the endorsement of customer 102. FIG. 7 shows an example update message 706 posted on social network as “XYZ likes ABC coffee shop, and is enjoying free Internet access at the location” (XYZ being an example customer 102 and ABC coffee shop being an example business entity 104). Other forms of example update message 706 such as including the item (e.g., “Almond Mocha”) that the example customer 102 purchased at business entity 104 therein are also within the scope of the exemplary embodiments. Further, in an example embodiment, ABC coffee shop (an example business entity 104) may be placed in the list of items associated with XYZ's “likes” (e.g., Likes 720) on social networking profile 702.

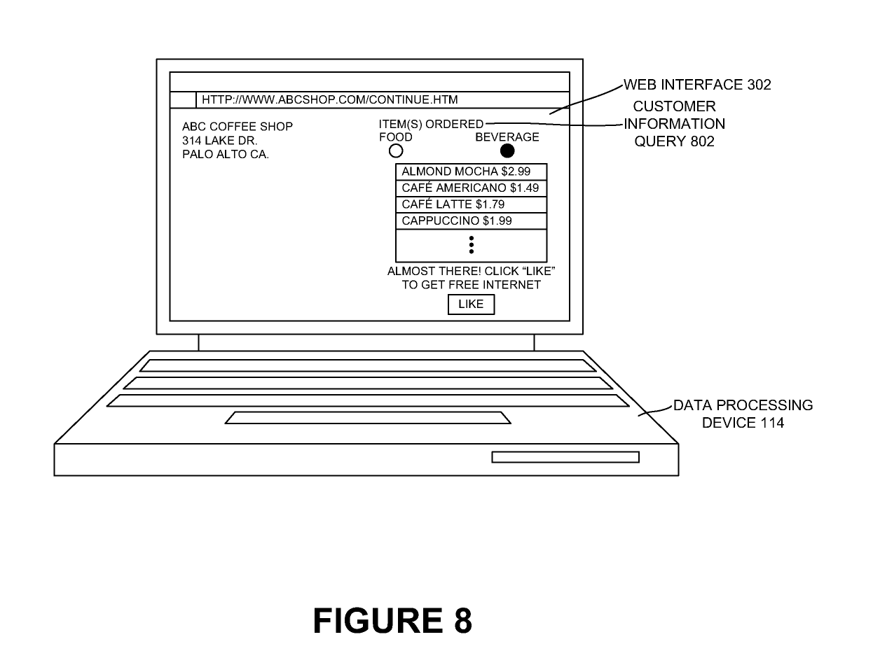

FIG. 8 shows another example web interface 302 requiring customer 102 to enter details of the item purchased. In addition to web interface 302 of FIG. 3 providing the interface for customer 102 to endorse business entity 104 on social network 220 through a “Like” button, web interface 302 shown in FIG. 8 may also obtain information from customer 102 such as the item ordered. FIG. 8 shows customer information query 802 portion of web interface 302 as requiring customer 102 to pick the item ordered from a list of choices. In the example web interface 302 of FIG. 8, customer 102 may be required to choose between food items and beverages. Upon clicking one of the two (say, beverages), customer 102 may be shown a drop-down list of beverage items available on the menu of business entity 104 such as Almond Mocha $2.99, Cappuccino $1.99, Café Latte $1.79, Café Americano $1.49 etc. Other distinctions such as distinctions in size of the beverage served may be made by, for example, distinguishing between a large and a medium size as Almond Mocha (Large) $3.99 and Almond Mocha (Medium) $2.99 (not shown).

The abovementioned example of extracting information from customer 102 is merely shown for illustrative purposes. Other example implementations of web interface 302 are within the scope of the exemplary embodiments discussed herein. In an example implementation, the requirement of customer 102 to input information prior to endorsing business entity 104 may be made optional. The information input by customer 102 may be utilized to apprise social networking friends and/or social networking subscribers of customer 102 with the offer of free Internet enjoyed by customer 102.

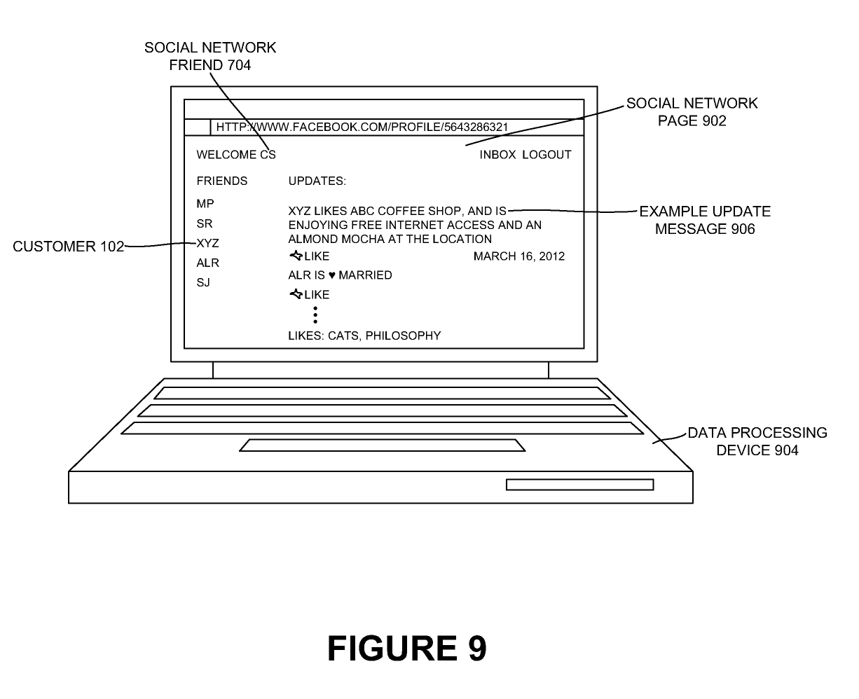

FIG. 9 shows an example social network page 902 of a social network friend 704 of customer 102 on a data processing device 904, according to one or more embodiments. In one or more embodiments, social network page 902 may be arrived at by social network friend 704 logging into a social networking account thereof (e.g., a facebook® account's wall page). FIG. 9 shows an example update message 906 posted to social networking page 902 as “XYZ likes ABC coffee shop, and is enjoying free Internet access and an Almond Mocha at the location.” Once again, other forms of example update message 906 are within the scope of the exemplary embodiments. In one or more embodiments, in addition to social network friends 704 of customer 102, subscribers (not shown) of customer 102 in a social network and/or fellow group members in the social network may also be updated with the example update message(s) (analogous to messages shown in FIG. 7 and FIG. 9) shown above.

Thus, in one or more embodiments, through posting an example update message (e.g., example update message 706) on social networking profile 702 (or, page) associated with customer 102 (an example patron of business entity 104), friends, subscribers and/or group members associated with customer 102 may receive a “social recommendation” through customer 102, which represents a powerful form of marketing for business entity 104. Moreover, as the social network formed by customer 102, social network friends 704 and friends of friends grows exponentially with the degrees from which a profile is removed from customer 102, such a marketing tactic may prove to be extremely rewarding to business entity 104. In one or more embodiments, the prospective larger fan base for business entity 104 may be enhanced through subsequent promotions and/or announcement(s) on the social network by business entity 104, for which social network friends 704 also serve as targets.

In one or more embodiments, one or more marketing service(s) such as Groupon™, OpenTable® and Yelp® may work well with the abovementioned business model of providing free Internet access to customer 102 in exchange for a social network endorsement because merchants (or, business entities 104) associated with the aforementioned marketing services may find it easier to lock in the loyalty of new patrons for repeated business through the business model instead of repeatedly having to “tempt” new patrons with discount coupons. Also, the business model discussed above may be combined with discount coupons to attract new patrons.

In one or more embodiments, the business model may be tailored to loyalty programs that direct benefits to most-deserving (depending on frequency) patrons. With regard to the free Internet access, for example, a length of time of the free Internet access may be increased for deserving patrons. It is obvious that the reward of increased free Internet time for deserving patrons may be combined with other discount offers.

In one or more embodiments, the business model discussed above may utilize the power of the Internet to create two-way communication link(s) with customers (e.g., customer 102), with customer 102 creating a lot of content around the business associated with business entity 104. This may be in direct contrast to forms of marketing that involve a one-way communication link from a business to a customer, where the same marketing message(s) are broadcast to all customers.

In one or more embodiments, third party 120 providing social network enabled router 106 may provide an interface through social network enabled router 106 for a representative of business entity 104 to set/control Internet access time. For example, a first time customer 102 may be provided free Internet access for about 0.5 hours, and a repeat customer 102 may be provided free Internet access for about 0.75 hours. Variations in the time are, obviously, within the scope of the exemplary embodiments.

It may be possible for customer 102 to re-register and continue to enjoy free Internet access. Each time the user registers/logs into the social networking account thereof, the user may have to endorse business entity 104 once again, thereby leading to free advertising and repeat endorsement on behalf of business entity 104.

For rare customers (e.g., customer 102) who lack a social network account, social network router 106 may be configured to direct customer 102 to a web page that is configured to generate a pass code for free Internet access (e.g., generated through third party server 170 or business entity server 160 shown below). The aforementioned pass code, when entered, may enable the free Internet access. In an example embodiment, customer(s) 102 lacking a social network account may be provided Internet access by way of the pass code for a lesser time compared to the Internet access time of customer(s) 102 with a social network account. Alternately, the pass code may be available over-the-counter at the location of business entity 104. The pass code may also be utilized by a friend or an associate of customer 102 at the location of business entity 104. Also, entities (individuals/businesses) also with social network enabled router(s) 106 may provide Internet access to other entities at location(s) associated therewith based on the pass code.

Other forms of providing control to Internet access to a representative of business entity 104 such as modifying a portion of the Internet bandwidth being shared with customer 102 and modifying the Service Set Identifier (SSID) being broadcast to customer 102 may be provided by way of social network enabled router 106.

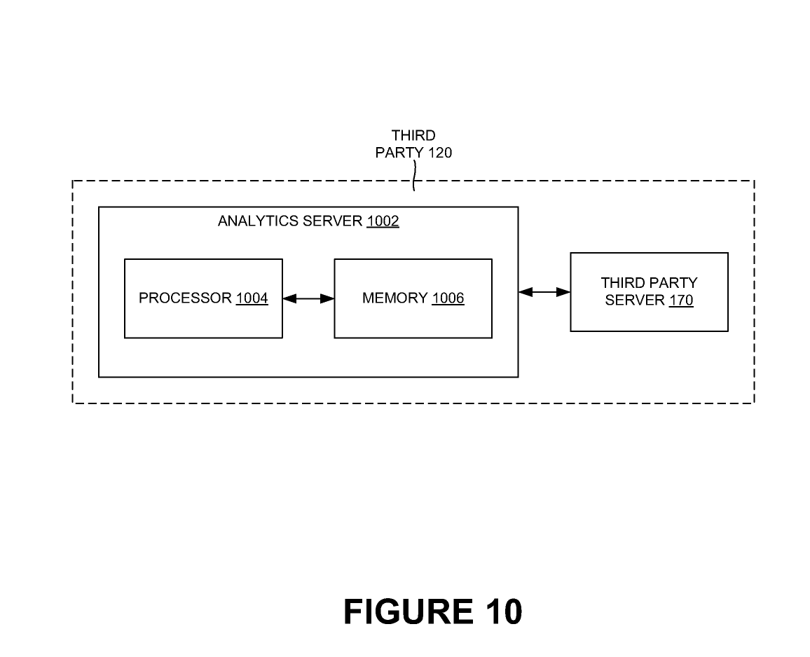

FIG. 10 shows an analytics server 1002 associated with third party server 170 having customer 102 data being routed thereto, according to one or more embodiments. In one or more embodiments, analytics server 1002 may include processor 1004 communicatively coupled to memory 1006 executing instructions associated with generating analytics reports based on customer 102 data (and/or data associated with other customer(s) 102 (not shown) of business entity 104) routed to analytics server 1002. In one or more embodiments, thus, third party 120 may provide analytics to business entity 104 based on customer 102 data as a service.

It is obvious that more than one customer 102 may be enjoying free Internet access at the location of business entity 104. FIG. 1 merely shows one customer for the purposes of simplicity and clarity in explanation. Also, business entity 104 may be the same as third party 120. In one example embodiment, business entity server 160 may be coupled to both third party server 170 and data processing device 114 through Internet 112 (see FIG. 1). Structural and functional variations in the exemplary embodiments discussed above consistent with the business model of providing free Internet access in exchange for a social network endorsement are within the scope of the exemplary embodiments. Further, it is obvious that one or more functionalities associated with social network enabled router 106 may be performed through processor 504 communicatively coupled to memory 506.

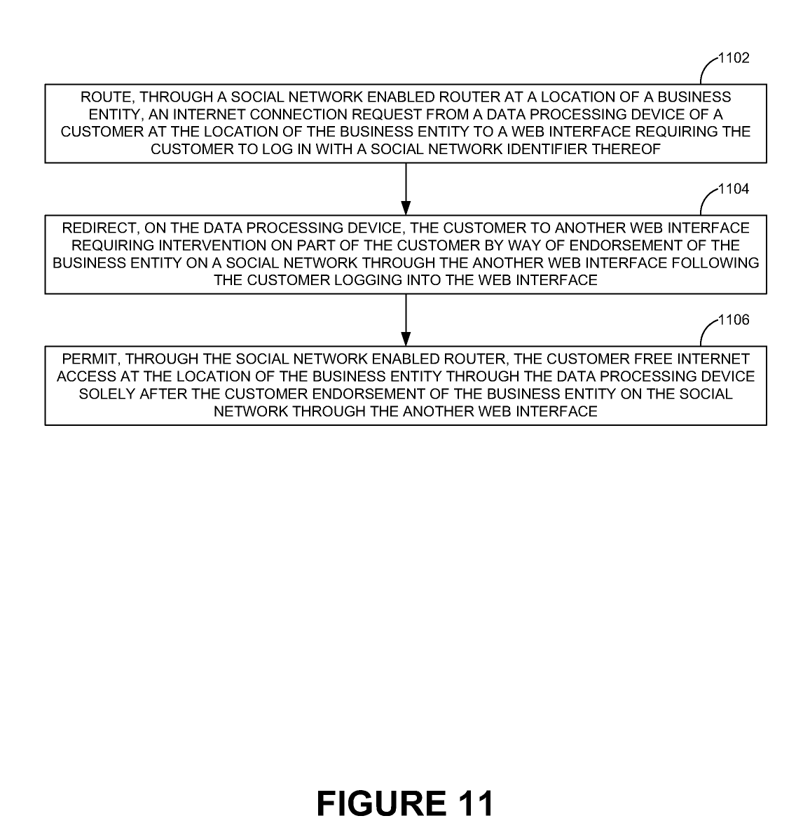

FIG. 11 shows a process flow diagram detailing operations involved in a method of providing free Internet access to customer 102 of business entity 104 through social network enabled router 106, according to one or more embodiments. In one or more embodiments, operation 1102 may involve routing, through social network enabled router 106 at a location of business entity 104, an Internet connection request from data processing device 114 of customer 102 of business entity 104 at the location thereof to a web interface (e.g., web page 202) requiring customer 102 to log in with a social network identifier thereof. In one or more embodiments, operation 1104 may involve redirecting, on data processing device 114, customer 102 to another web interface (e.g., web interface 302) requiring intervention on part of customer 102 by way of endorsement of business entity 104 on social network 220 through the another web interface (e.g., web interface 302) following customer 102 logging into the web interface (e.g., web page 202). In one or more embodiments, the another web interface (e.g., web interface 302) may be configured to operate on a platform (e.g., social network platform 240) of social network 220.

In one or more embodiments, operation 1106 may then involve permitting, through social network enabled router 106, customer 102 free Internet access at the location of business entity 104 through data processing device 114 solely after the customer endorsement of business entity 104 on social network 220 through the another web interface (e.g., web interface 302).

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative rather than a restrictive sense.

What is claimed is:

1. A method comprising:
routing, through a social network enabled router at a location of a business entity, an Internet connection request from a data processing device of a customer of the business entity at the location thereof to a web interface requiring the customer to log in with a social network identifier thereof;
redirecting, on the data processing device, the customer to another web interface requiring intervention on part of the customer by way of endorsement of the business entity on a social network through the another web interface following the customer logging into the web interface, the another web interface being configured to operate on a platform of the social network, and the social network corresponding to the social network identifier of the customer; and
permitting, through the social network enabled router, the customer free Internet access at the location of the business entity through the data processing device solely after the customer endorsement of the business entity on the social network through the another web interface.

2. The method of claim 1, further comprising at least one of:
triggering the platform of the social network to post a message related to at least one of patronization of the business entity by the customer and the free Internet access on a social networking profile of the customer on the social network after the customer endorses the business entity on the social network; and
generating, through at least one of a third party server associated with a third party provider of the social network enabled router and a business entity server associated with the business entity, a pass code for the free Internet access if the customer does not possess the social network identifier.

3. The method of claim 1, further comprising providing, through the social network enabled router, an interface for the business entity to at least one of:
control a time of the free Internet access,
modify a portion of Internet bandwidth shared with the data processing device of the customer, and
modify a Service Set Identifier (SSID) broadcast to the data processing device during the free Internet access.

4. The method of claim 3, wherein controlling the time of the free Internet access includes increasing the time of the free Internet access if the customer is a repeat customer of the business entity.

5. The method of claim 2, further comprising:
routing, through the social network enabled router, data associated with at least one of the customer and other customers of the business entity to an analytics server associated with the third party provider; and
generating, through the analytics server, an analytics report based on the data routed thereto.

6. A router configured to enable Internet access in a location of a business entity comprising:
a memory; and
a processor communicatively coupled to the memory, the processor being configured to execute instructions associated with:
routing an Internet connection request from a data processing device of a customer of the business entity at the location thereof to a web interface requiring the customer to log in with a social network identifier thereof, and
permitting the customer free Internet access at the location of the business entity through the data processing device solely after the customer endorses the business entity on a social network through another web interface to which the customer is redirected to on the data processing device following the login thereof with the social network identifier thereof, the another web interface being configured to operate on a platform of the social network, and the social network corresponding to the social network identifier of the customer.

7. A system comprising:
a data processing device of a customer of a business entity at the location of the business entity; and
a social network enabled router at the location of the business entity, the social network enabled router being configured to:
route an Internet connection request from the data processing device to a web interface requiring the customer to log in with a social network identifier thereof, and
permit the customer free Internet access at the location of the business entity through the data processing device solely after the customer endorses the business entity on a social network through another web interface to which the customer is redirected to on the data processing device following the login thereof with the social network identifier thereof, the another web interface being configured to operate on a platform of the social network, and the social network corresponding to the social network identifier of the customer.

8. The system of claim 7, wherein at least one of:
the platform of the social network is triggered to post a message related to at least one of patronization of the business entity by the customer and the free Internet access on a social networking profile of the customer on the social network after the customer endorses the business entity on the social network, and
the system further comprises at least one of a third party server associated with a third party provider of the social network enabled router and a business entity server associated with the business entity to generate a pass code for the free Internet access if the customer does not possess the social network identifier.

9. The system of claim 7, wherein the social network enabled router is configured to provide an interface for the business entity to at least one of:
control time of the free Internet access,
modify a portion of Internet bandwidth shared with the data processing device of the customer, and
modify a Service Set Identifier (SSID) broadcast to the data processing device during the free Internet access.

10. The system of claim 8, further comprising:
an analytics server associated with the third party provider, the analytics server being configured to generate an analytics report based on having data associated with at least one of the customer and other customers of the business entity routed thereto through the social network enabled router.
